(19) United States
(12) Patent Application Publication
(10) Pub. No.: US 2008/0123541 A1
(43) Pub. Date: May 29, 2008

(54) Method For Allocating Data To At Least One Packet In An Integrated Circuit

(75) Inventors: John Dielissen, Eindhoven (NL); Kees Gerard Willem Goossen, Eindhoven (NL); Andrei Radulescu, Eindhoven (NL); Edwin Rijpkema, Nieuwerkerk a/d Ijssel (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,360

(22) PCT Filed: Jul. 26, 2005
(86) PCT No.: PCT/IB2005/052512

§ 371 Date: Feb. 7, 2007

(30) Foreign Application Priority Data
Aug. 12, 2004 (EP) 04103878.7

(51) Int. Cl. H04L 12/26

(52) U.S. Cl. 370/252

(57) ABSTRACT

The invention relates to a method for allocating data to at least one packet in an integrated circuit, the integrated circuit comprising a network through which the packet is sent from a first module to at least one second module, the method comprising the step of determining the length of the packet. The length of a packet is determined on basis of dynamically known parameters instead of statically known parameters, which increases flexibility with regard to the allocation of data units to packets. The method of packetization takes into account runtime aspects when determining the length of the packets to be transmitted via the communication channels of the network.

The invention relates to a method for allocating data to at least one packet in an integrated circuit, the integrated circuit comprising a network through which the packet is sent from a first module to at least one second module, the method comprising the step of determining the length of the packet.

The invention also relates to an integrated circuit comprising a network for sending at least one packet from a first module to at least one second module, the integrated circuit comprising a means for allocating data to the packet, wherein the means is arranged to determine the length of the packet.

Systems on silicon show a continuous increase in complexity due to the ever-increasing need for implementing new features and improvements of existing functions. This is enabled by the increasing density with which components can be integrated on an integrated circuit. At the same time the clock speed at which circuits are operated tends to increase too. The higher clock speed in combination with the increased density of components has reduced the area which can operate synchronously within the same clock domain. This has created the need for a modular approach. According to such an approach the processing system comprises a plurality of relatively independent, complex modules. In conventional processing systems the modules usually communicate to each other via a single bus. As the number of modules increases however, this way of communication is no longer practical for the following reasons. First, the large number of modules forms a too high bus load. Second, the bus forms a communication bottleneck as it enables only one device to send data to the bus. A communication network forms an effective way to overcome these disadvantages. It is noted that such a communication network may cover multiple chips, which type of network is often referred to as a multi-chip network. Multi-chip networks have become increasingly important in recent developments.

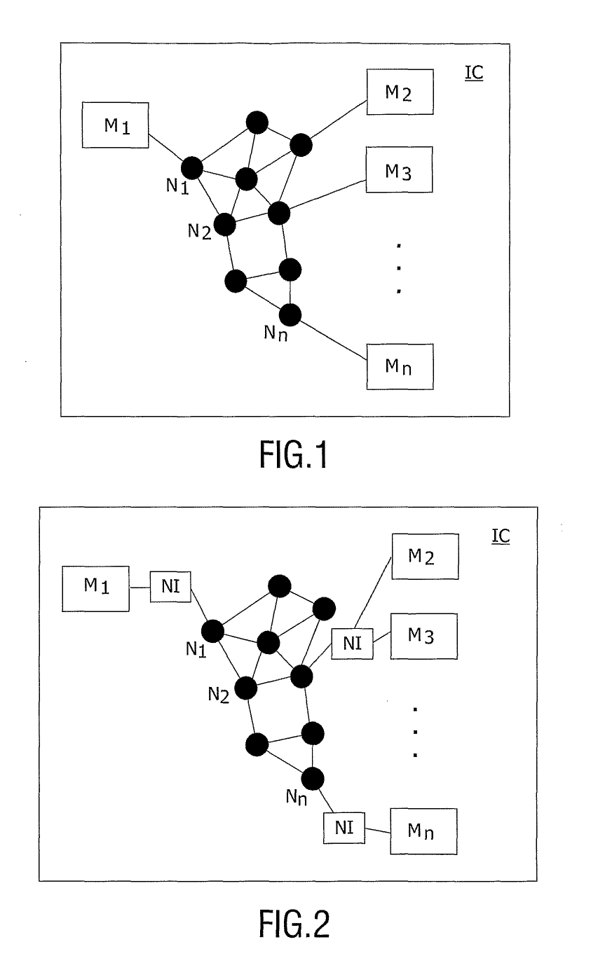

The communication network, which is often referred to as a Network-on-Chip (NoC), comprises a collection of nodes (e.g. routers) and connections between these nodes. The modules are typically connected to the network via so-called network interfaces. A network interface has (among other tasks) the task of splitting messages to be sent over the network into packets. These packets have the correct format for transport via the network. The packets typically comprise a header, a tail and a payload (see FIG. 1). The payload comprises the data which should be transported via the network from a first module to one or more second modules. The process of splitting a message containing these data into one or more packets is often referred to as the packetization process.

During packetization the data comprised in a message is split into one or more parts and these parts are allocated to one or more packets. Typically, the length of such a packet is determined using statically known parameters such as the size of a message and the maximum payload per packet. For example, if the message length is 10 units of data and the maximum payload per packet is 4 units of data, then the message can be divided into 3 packets with a payload of respectively 4 units of data, 4 units of data and 2 units of data. The units of data are usually words, so the message is divided into 3 packets with a payload of respectively 4 words, 4 words and 2 words.

In “QnoC: QoS architecture and design process for network on chip”, by Evgeny Bolotin et al., Journal of Systems Architecture 50 (2004), pages 105-128, an architecture for on-chip packet-switched networks is provided. This architecture enables the use of priorities for packets with a predetermined size, in the sense that packets can belong to different classes of service and packets of different classes are forwarded in an interleaved manner. High priority packets can pre-empt the transmission of a lower priority packet. The transmission of the interrupted lower priority packet is resumed only after all higher priority packets are serviced. This enables swift processing of higher priority data traffic, but it requires a relatively complex priority mechanism which is implemented in the routers of the network.

A major disadvantage of the known methods of packetization is that the performance of the network is negatively affected. A network interface implementing the packetization process either waits until it will have received the complete message from the first module, or it starts the packetization process when it has received a first part of the message. In the first case, buffering is required in the network interface and the latency is increased. In the second case, the connection between the first module and the network interface must be kept occupied while the message is being delivered to the network interface. This causes an increase of latency for other data streams and underutilization of the network if the message does not arrive immediately. It is possible to guarantee that the first module sends at least a substantial number of data units, but this restricts the application because the first module may not be interrupted nor stopped for a certain period of time. For real-time applications this may be an unacceptable constraint.

Another disadvantage relates to the costs of the network in terms of hardware resources. For example, if packet-based communication is used over a time-based circuit-switching network, then a packet has to fit in a number of reserved consecutive slots in the slot-table of a router. To satisfy this constraint the starting point of the communication must be limited: when the packet is at most in slots long, the communication can only start if from that point on m consecutive slots are reserved. This reduces the possibilities for making reservations in the slot-table, because at least one block of m consecutive slots has to be reserved. Reserved blocks should be of this size because blocks containing less slots are skipped entirely by the packets, resulting in a waste of slots and consequently in a waste of valuable bandwidth. Furthermore, the amount of reservations should be done such that the missing of slots does not lead to a situation in which no guaranteed traffic service can be given. There are too may claimed resources in this situation and therefore the method of packetization is too expensive.

It is an object of the invention to provide a method for spreading data among at least one packet in an integrated circuit, which method has a positive effect on the performance of the integrated circuit and which reduces the cost of the integrated circuit.

This object is achieved by providing a method, characterized by the characterizing portion of claim 1. The object is also achieved by providing an integrated circuit, characterized by the characterizing portion of claim 11. The length of a packet is determined on basis of dynamically known parameters instead of statically known parameters, which increases flexibility with regard to the allocation of data units to packets. The method of packetization takes into account runtime aspects when determining the length of the packets to be transmitted via the communication channels of the network.

In an embodiment of the method according to claim 2, the length of the packet is determined substantially close to ending the packet, which further increases the flexibility of the solution. In an embodiment of the method according to claim 3, the length of the packet is determined by a network interface.

The embodiments of the method as defined in claim 4 up to and including claim 10 comprise various examples of dynamically known parameters, which will be explained in the description of preferred embodiments. The dynamically known parameters represent, respectively:

the amount of data which can be sent to a second module;

the number of units of data available in the queues of the network interface;

the number of consecutive slots reserved in a slot-table;

the number of pending requests to the network interface for access to the network;

the priority of pending requests to the network interface for access to the network;

the extent to which queues associated with pending requests to the network interface for access to the network are filled;

a runtime indicator for a current maximum packet-size.

The present invention is described in more detail with reference to the drawings, in which:

FIG. 1 illustrates a known integrated circuit comprising a first module, a plurality of second modules and a network;

FIG. 2 illustrates a known integrated circuit comprising a first module, a plurality of second modules, a network and a network interface which couples the first module to the network;

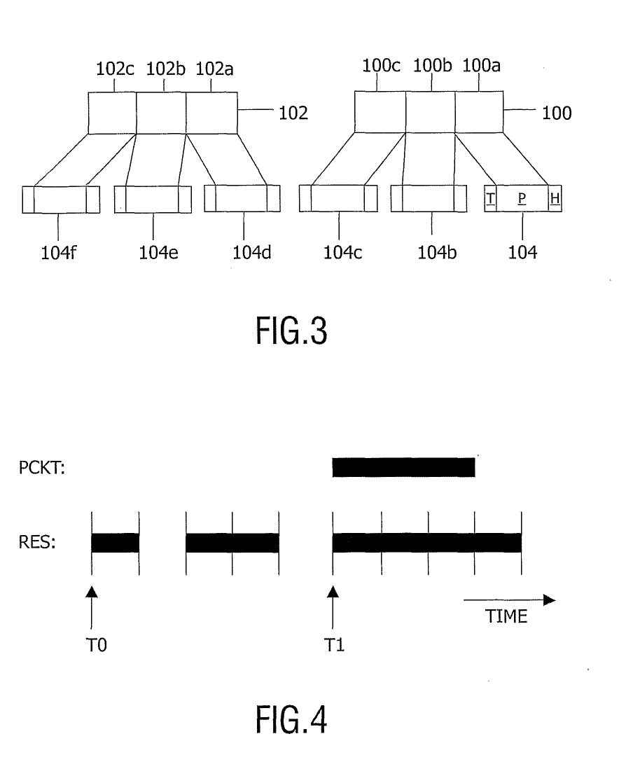

FIG. 3 illustrates a known method for spreading data among at least one packet in an integrated circuit comprising a network;

FIG. 4 illustrates a known method of timing the transmission of packets;

FIG. 5 illustrates a method of timing the transmission of packets according to the invention.

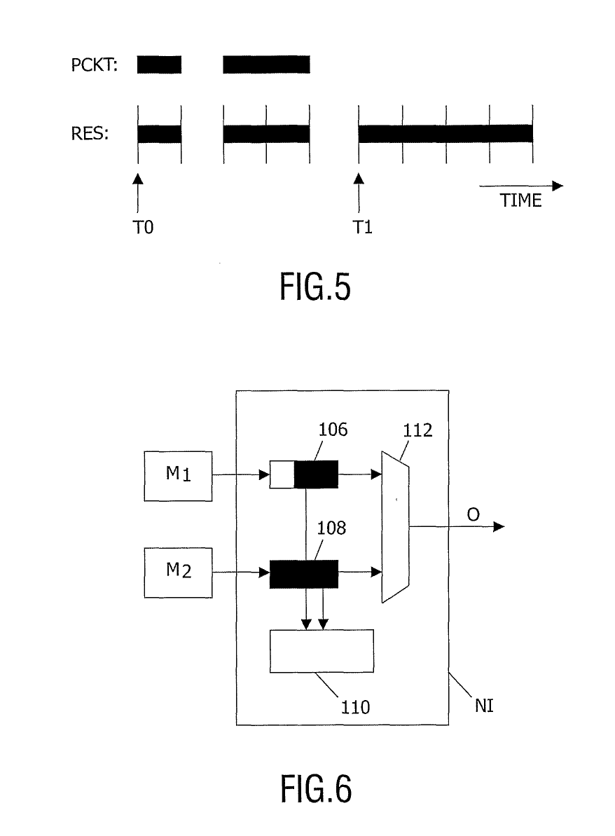

FIG. 6 illustrates an example of a queuing mechanism in a network interface;

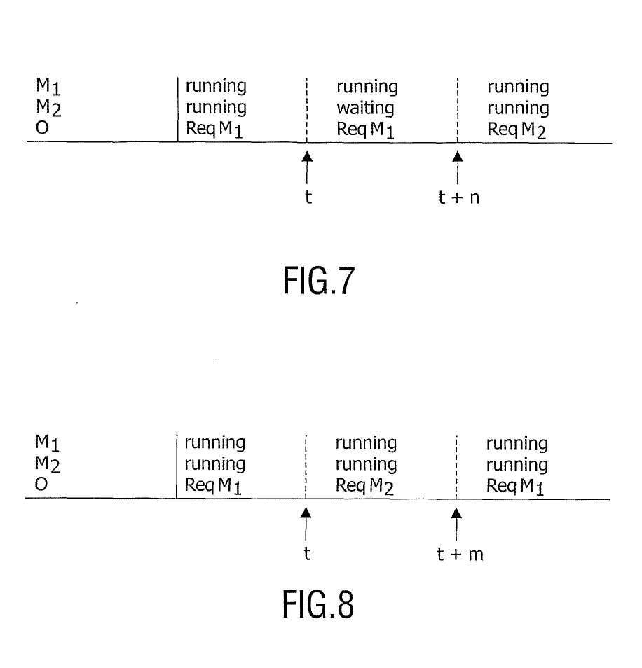

FIG. 7 illustrates a known method of producing an output signal of the network interface as illustrated in FIG. 6;

FIG. 8 illustrates a method of producing an output signal of the network interface as illustrated in FIG. 6, according to the invention.

FIG. 1 illustrates a known integrated circuit IC comprising a first module M₁, a plurality of second modules M₂, M₃, . . . , Mₙ and a network comprising a plurality of nodes N₁, N₂, . . . , Nₙ. Messages comprising data can be transmitted through the network, for example from the first module M₁ to one of the second modules M₂, M₃, . . . , Mₙ or to more than one second module. The nodes N₁, N₂, . . . , Nₙ of the network may for example be routers which are adapted to route messages to the correct destination. A message is typically split into packets which comprise a header, a payload and a tail. The header usually comprises information regarding the final destination of a packet, e.g. an identifier of the addressed second module. The payload comprises the actual data (i.e. a part of the message) that should be transmitted to the second module. The tail may be used for various purposes, e.g. to store information which is used for detecting transmission errors.

FIG. 2 illustrates a known integrated circuit IC comprising a first module M₁, a plurality of second modules M₂, M₃, . . . , Mₙ, a network and at least one network interface NI which couples the modules to the network. The network interface (NI) is a component which performs various interface functions for the modules. It is noted that a network interface may be coupled to more than one module; it then performs the said interface functions for these modules and typically implements prioritization or arbitration functionality for messages from different modules. The modules are sometimes referred to as requesters, because they request access to the network for the message(s) to be sent. Typically, the network interface NI is also responsible for preparing the messages for transmission, i.e. splitting the messages into parts and spreading these parts among the packets.

FIG. 3 illustrates a known method for spreading data among at least one packet in an integrated circuit comprising a network. A first message 100 and a second message 102 are split into parts and spread among the packets 104a, 104b, . . . , 104f. Part 100a of the first message 100 is allocated to the payload P of packet 104a, part 100b is allocated to the payload of packet 104b etc., and finally part 102c of the second message 102 is allocated to the payload of packet 104f. Each packet 104a, 104b, . . . , 104f comprises a header H, a payload P and a tail T, as explained above. In this method of packetization the length of a packet is determined using statically known parameters such as the size of a message and the maximum payload per packet. For example, if the message length is 10 units of data and the maximum payload per packet is 4 units of data, then the message can be divided into 3 packets with a payload of respectively 4 units of data, 4 units of data and 2 units of data.

A disadvantage of this method of packetization is that the performance of the network is negatively affected. Another disadvantage relates to the costs of the network in terms of hardware resources; there are too many claimed resources and therefore the method of packetization is too expensive. These disadvantages have as underlying problem that the method of packetization does not take into account runtime events. The size of packets is determined using statically known parameters and therefore the size of the packets may not be well-chosen for certain runtime situations. An example of this disadvantage is given in FIG. 4.

FIG. 4 illustrates a known method of timing the transmission of packets PCKT.

The reservation of consecutive slots in a slot-table RES must be taken into account. Conceptually the slot-table resides in the network interface NI and the routers of the network. Physically the slot-table may reside in the network interface NI, for example. The minimal number of reserved consecutive slots in the slot-table RES is 3, because the packet PCKT to be sent fits into 3 consecutive slots. The transmission of the packet PCKT cannot begin until T1, because the first available block of consecutive slots contains only 1 slot and the second available block contains 2 slots, both of which are not big enough to accommodate the packet PCKT of size 3. However, the transmission could have begun at T0 if a block of sufficient size had been reserved at T0. This situation results in a waste of time and resources.

The method of packetization according to the invention takes into account runtime events by using dynamically known parameters for determining the size of a packet. Examples of such dynamically known parameters are:

the amount of data which can be sent to an addressed module (flow control);

the amount of data available in the queues of the network interface;

the availability of a reserved block of consecutive slots in a slot-table;

the number of other requests for access to the network;

the priority of such other requests;

the filling of queues associated with such other requests; and

a runtime indicator for a current maximum packet-size.

The length of the packet can be decided at the latest moment, e.g. immediately before or close to ending the packet, which increases the flexibility of the solution. The various examples of dynamically known parameters will now be explained.

The amount of data which can be sent to an addressed module is typically determined using a credit-based flow control mechanism. If this amount of data is relatively large, larger packets can be constructed for transmission to the addressed module. The amount of data available in the queues of the network interface is another parameter, which reflects the situation at the input side of the transmission channel. If a relatively large amount of data resides in a queue, packets can be made larger which is more efficient. It will be appreciated that these dynamically known parameters are complementary, in the sense that both the amount of data at the input side of the transmission channel and the amount of data at the output side of the transmission channel are important for determining the correct packet-length. The method of packetization may use a combination of these parameters for determining the packet-length.

Determination of the length of the packets on basis of the availability of reserved blocks of consecutive slots in a slot-table will be explained with reference to FIG. 5.

The number of other requests for access to the network is another example of a relevant dynamically known parameter. If there are many requests for access to the network, the choice may be to reduce the length of the packets such that all requests can be granted and proceed in a pseudo-simultaneous manner. The priority of such other requests is also important when determining the correct packet-length. Furthermore, the filling of queues associated with such other requests is an important runtime parameter, which will be explained with reference to FIG. 6. Again it will be appreciated that the method of packetization may use a combination of these parameters for determining the packet-length.

A runtime indicator for a maximum packet-size can also be deployed for determining the length of the packets. For example, round-trip latency can be used to determine the value of this runtime indicator.

FIG. 5 illustrates a method of timing the transmission of packets according to the invention. In this example, the length of the packets PCKT is determined on basis of the availability of reserved blocks of consecutive slots in the slot-table RES. At T0, a block of one slot is available, a successive slot is occupied, and then two slots are available. The message is split dynamically into two packets of respectively one and two slots. In this manner, the transmission of the message can begin at T0 instead of T1.

FIG. 6 illustrates an example of a queuing mechanism in a network interface NI. In this example, the length of a packet is determined on basis of the filling of other requests for access to the network. A first module M₁ requests access to the network for sending a first message. A second module M₂ requests access to the network for sending a second message. The data of the first message is queued in a first queue 106 comprised in the network interface NI. The data of the second message is queued in a second queue 108 comprised in the network interface NI. A packetization unit 110 has read access to the queues 106 and 108. The packetization unit 110 controls a multiplexer unit 112, the multiplexer unit 112 being arranged to select data from queues 106 and 108 for placement on the output O to the network. As can be seen from FIG. 6 the first queue 106 is filled with data, but it is not full. The second queue 108 is filled completely with data and if it is not emptied, then the second module M₂ can no longer send data to it.

If the packetization unit 110 applies a state-of-the-art method of packetization, it will not take into account that the second queue 108 is full. FIG. 7 illustrates a known method of producing an output signal of the network interface as illustrated in FIG. 6. In that example, the packetization unit 110 decides that data from the first queue 106 must be selected for placement on the output O, because there are enough units of data in the first queue 106 to continue for a number n of flits and the maximal packet-length is sufficient. If the second queue 108 gets full, then the communication between the network interface NI and the second module M₂ will block, which will force this module to stop running. So at moment t in time the second module M₂ is waiting until the data in the first queue 106 has been processed. At moment t+n the first queue 106 is empty and the data from the second queue 108 can be selected for placement on the output O.

FIG. 8 illustrates a method of producing an output signal according to the invention. If the packetization unit 110 applies the method of packetization according to the invention, the detection of a ‘queue full’ condition of the second queue 108 at moment t will lead to a break in the processing of data from the first queue 106. In this manner the second module M₂ does not get stalled. If the second queue 108 contains enough data to continue for m flits, then at moment t+m data from the first queue 106 will be selected again.

It is noted that where reference is made to the pending requests for access to the network, it is possible that a credit-based end-to-end flow control mechanism is used, which optimizes the arbitration process for pending requests. A pending request is then the minimum of the available data and the credit. This is relevant for claims 7, 8 and 9, wherein ‘pending requests’ can be interpreted in this manner.

It is remarked that the scope of protection of the invention is not restricted to the embodiments described herein. Neither is the scope of protection of the invention restricted by the reference symbols in the claims. The word ‘comprising’ does not exclude other parts than those mentioned in a claim. The word ‘a(n)’ preceding an element does not exclude a plurality of those elements. Means forming part of the invention may both be implemented in the form of dedicated hardware or in the form of a programmed general-purpose processor. The invention resides in each new feature or combination of features.

1. A method for allocating data to at least one packet (PCKT) in an integrated circuit (IC), the integrated circuit (IC) comprising a network through which the packet (PCKT) is sent from a first module (M₁) to at least one second module (M₂, M₃, . . . , Mₙ), the method comprising the step of determining the length of the packet (PCKT), characterized in that the length of the packet (PCKT) is determined on basis of at least one dynamically known parameter, the value of the parameter being known when the integrated circuit (IC) is in operation.

2. A method as claimed in claim 1, wherein the length of the packet (PCKT) is determined substantially close to ending the packet (PCKT).

3. A method as claimed in claim 1, wherein the length of the packet (PCKT) is determined by a network interface (NI).

4. A method as claimed in claim 1, wherein the dynamically known parameter indicates the amount of data which can be sent to the second module (M₂, M₃, . . . , Mₙ).

5. A method as claimed in claim 3, wherein the dynamically known parameter indicates the number of units of data available in the queues (106, 108) of the network interface (NI).

6. A method as claimed in claim 1, wherein the dynamically known parameter indicates the number of consecutive slots reserved in a slot-table (RES).

7. A method as claimed in claim 3, wherein the dynamically known parameter indicates the number of pending requests to the network interface (NI) for access to the network.

8. A method as claimed in claim 3, wherein the dynamically known parameter indicates the priority of pending requests to the network interface (NI) for access to the network.

9. A method as claimed in claim 3, wherein the dynamically known parameter indicates the extent to which the queues (106, 108) associated with pending requests to the network interface (NI) for access to the network are filled.

10. A method as claimed in claim 1, wherein the dynamically known parameter is a runtime indicator for a current maximum packet-size.

11. An integrated circuit (IC) comprising a network for sending at least one packet (PCKT) from a first module (M₁) to at least one second module (M₂, M₃, . . . , Mₙ), the integrated circuit (IC) comprising a means for allocating data to the packet (PCKT), wherein the means is arranged to determine the length of the packet (PCKT), characterized in that the means is further arranged to determine the length of the packet (PCKT) on basis of at least one dynamically known parameter, the value of the parameter being known when the integrated circuit (IC) is in operation.
